(19) United States
(12) Patent Application Publication
(10) Pub. No.: US 2012/0046971 A1
(43) Pub. Date: Feb. 23, 2012

(54) METHOD AND SYSTEM FOR IMAGING PATIENTS WITH A PERSONAL MEDICAL DEVICE

(75) Inventors: Matthew J. Walker, Willoughby, OH (US); Mark E. Olszewski, Solon, OH (US)

(73) Assignee: KONINKLIJKE PHILIPS ELECTRONICS N.V., EINDHOVEN (NL)

(21) Appl. No.: 13/266,576

(22) PCT Filed: Apr. 9, 2010
(86) PCT No.: PCT/IB2010/051542

§ 371 Date: Oct. 27, 2011

Related U.S. Application Data
(60) Provisional application No. 61/177,669, filed on May 13, 2009.

(51) Int. Cl. G06K 9/00; G06Q 50/24

(52) U.S. Cl. 705/3; 382/128

(57) ABSTRACT

A method and system are provided for detecting the presence of a personal medical device within a patient. A method and system are provided for determining the location and type of the personal medical device as well as other characteristics of the device. A method and system are provided for adapting or customizing a medical imaging procedure to avoid interfering with a personal medical device or to diminish the risk of device interference or malfunction. A method and system are provided for interfacing with health record databases, regulatory databases, medical device databases, or other types of databases to gather information regarding a particular patient's personal medical device and to update said databases with additional information regarding the personal medical device if any is gathered.

The present application relates generally to the medical imaging arts. More specifically, it provides a method and system for the detection of personal medical devices and for conducting medical imaging procedures on patients with a personal medical device. The application subject matter finds use at least with computed tomography (CT) imaging and will be described with particular reference thereto. However, it also has more general application with other imaging methods and in other arts, such as x-ray, fluoroscopy, magnetic resonance (MR), single-photon emission computed tomography (SPECT), positron emission tomography (PET), and ultrasound (US).

Recent studies have demonstrated the potential for interaction between personal medical devices and imaging radiation, such as x-ray radiation used in CT. Such personal medical devices include, but are not limited to, cardiac rhythm management devices, defibrillators, neurostimulators, drug infusion pumps (e.g., insulin pumps), cochlear implants, and retinal implants. X-ray radiation may interfere with the operation of a personal medical device or cause the device to malfunction. The interactions with x-ray radiation that may occur with these devices during CT scanning include the generation of spurious signals (e.g., cardiac defibrillation pulses), the misinterpretation or misdetection of device signals as actual physiological signals, and the resetting or reprogramming of the settings of the personal medical device. Each of these possible interactions may potentially result in adverse events.

At present, the likelihood of adverse events related to the x-ray induced personal medical device interference and/or malfunction is not completely understood or documented. Currently, most registered CT technologists have limited knowledge regarding personal medical devices. In addition, the type and location of personal medical devices varies greatly from patient to patient. There is also significant interpatient variation of the clinical factors exhibited by a patient that may indicate the presence of a personal medical device.

For the foregoing reasons and other reasons, it is desirable to provide a method and system for detecting the presence of a personal medical device and for gathering information regarding the device. In addition, it is desirable to provide a method and system to adapt or customize medical imaging procedures to diminish the risk of x-ray radiation interfering with a personal medical device. It is also desirable to provide a method and system to balance the image quality obtained by a particular medical imaging procedure with the risk of possible device interference or malfunction if it is necessary to scan over the personal medical device. Finally, it is also desirable to provide a system for interfacing with health record databases, regulatory databases, medical device databases, or other types of databases to gather information regarding a particular patient's personal medical device.

Aspects of the present invention address these matters, and others.

According to one aspect of the present invention, a method and system are provided for detecting the presence of a personal medical device within a patient. According to another aspect of the present invention, a method and system are provided for determining the location and type of the personal medical device as well as other characteristics of the device. According to another aspect of the invention, a method and system are provided for adapting or customizing a medical imaging procedure to avoid interfering with a personal medical device or to diminish the risk of device interference or malfunction. According to yet another aspect of the invention, a method and system are provided for balancing the image quality obtained by a particular medical imaging procedure with the risk of possible interference with a personal medical device if it is necessary to scan over a personal medical device. According to another aspect of the present invention, a method and system are provided for interfacing with health record databases, regulatory databases, medical device databases, or other types of databases to gather information regarding a particular patient's personal medical device and to update said databases with additional information regarding the personal medical device if any is gathered.

Still further aspects of the present invention will be appreciated by those of ordinary skill in the art upon reading and understanding the following detailed description. Numerous additional advantages and benefits will become apparent to those of ordinary skill in the art upon reading the following detailed description of preferred embodiments.

The invention may take form in various components and arrangements of components, and in various process operations and arrangements of process operations. The drawings are only for the purpose of illustrating preferred embodiments and are not to be construed as limiting the invention.

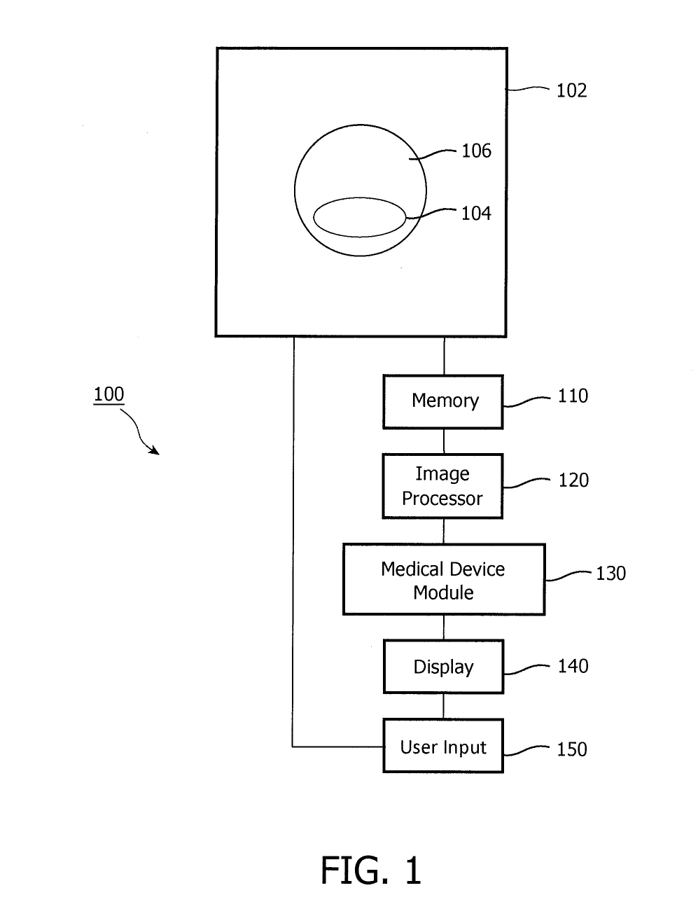

FIG. 1 is a schematic view of an exemplary CT imaging system according to an embodiment of the present invention;

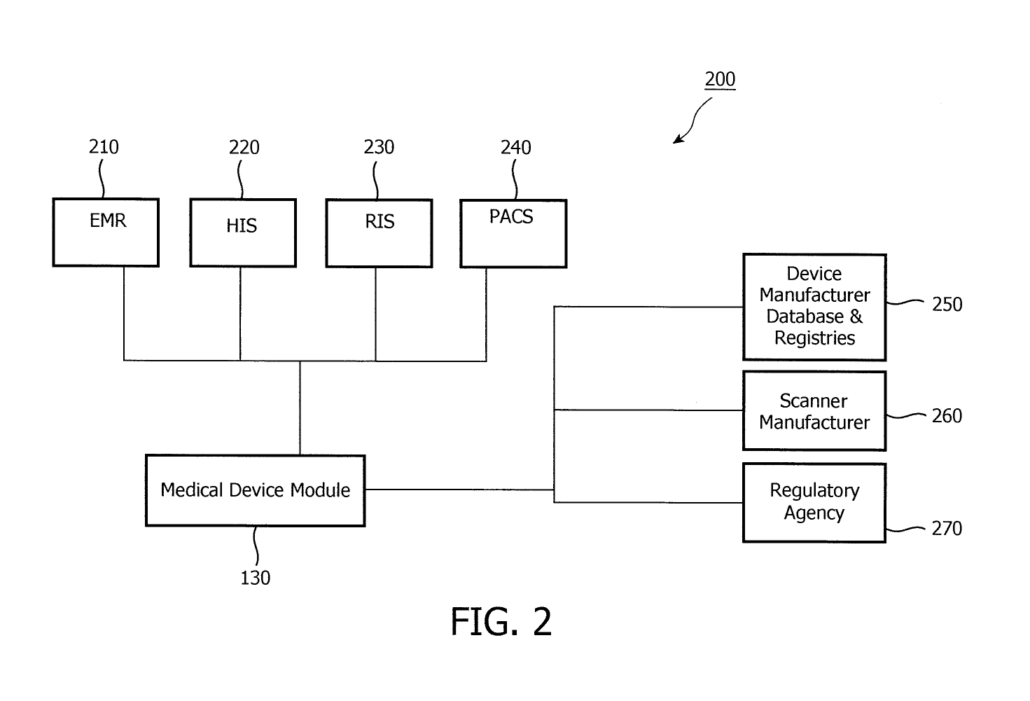

FIG. 2 is a schematic view of an exemplary medical imaging network according to an embodiment of the present invention;

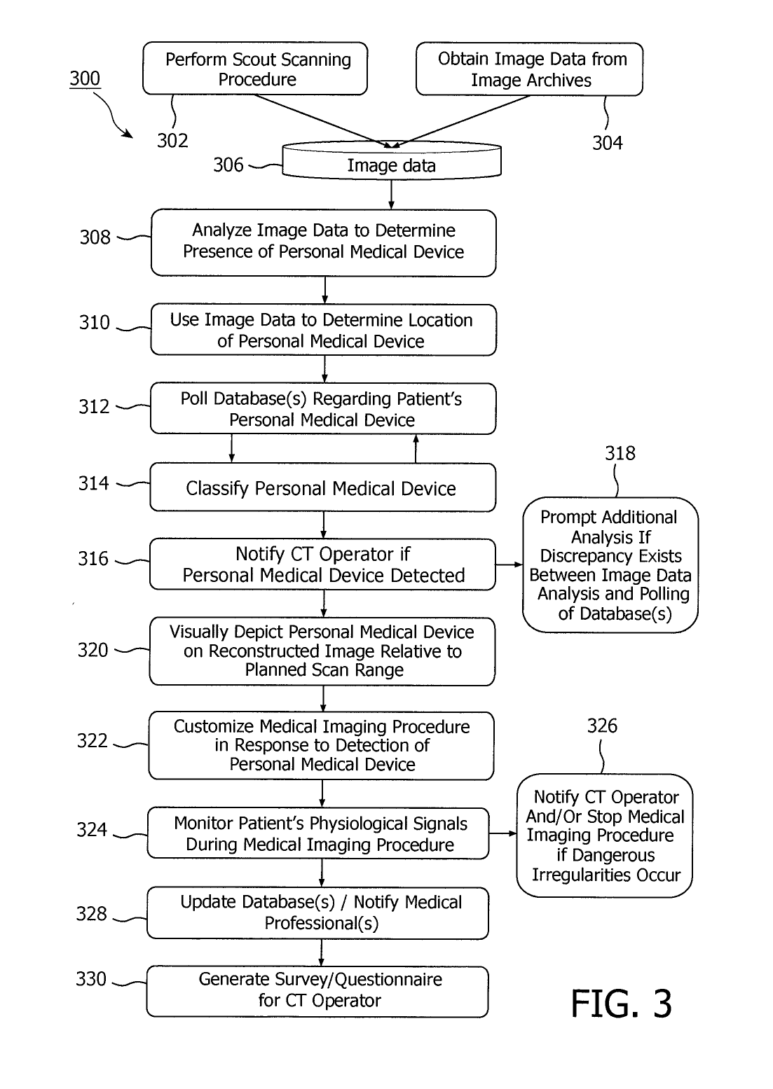

FIG. 3 depicts a medical imaging method according to an embodiment of the present invention;

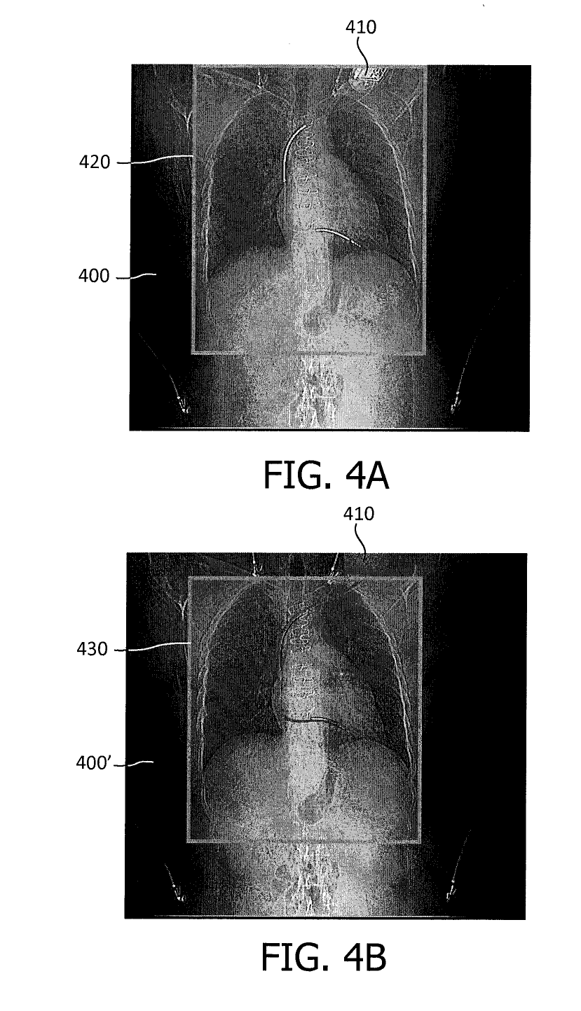

FIG. 4A is an exemplary reconstructed CT scout scan image generated by a software program showing an implanted cardiac rhythm management device (ICMRD) and illustrating a planned scanned range that includes the ICMRD; and

FIG. 4B is an exemplary reconstructed CT scout scan image generated by a software program according to one aspect of the present invention (of the same scout scan image of FIG. 4A) where the ICMRD has been detected and highlighted in the reconstructed CT image and illustrating a planned scan range that has been adjusted to diminish the risk of interference with the ICMRD.

Currently, many different kinds of imaging systems are used to obtain medical images. These kinds of imaging systems include CT, PET, SPECT, MRI, and other imaging systems. An exemplary CT imaging system 100 is illustrated in FIG. 1. As already mentioned, however, the imaging method and system disclosed herein also have application in connection with various other kinds of imaging systems or combinations of imaging systems other than the types expressly discussed herein.

As illustrated in FIG. 1, the exemplary CT imaging system 100 includes a CT imaging device 102. A representative subject to be imaged is shown at 104 in FIG. 1, partially received in an aperture 106 of the CT imaging device 102. The exemplary CT imaging system 100 also includes a memory 110, image processor 120, medical device module 130, display 140 and user input 150. The image processor 120 receives x-ray data from the CT imaging device 102 to generate CT images. The x-ray image data obtained by the CT imaging device 102 is stored in the memory 110. The x-ray image data stored in the memory 110 is processed by the imaging data processor 120. The processor 120 generates an image of the imaged subject 104, based on the x-ray image data, according to a mathematical algorithm or algorithms. The image can be displayed on an associated display 140. A user input 150 may be provided for a user to control the components of the CT imaging system 100. The various components of the CT imaging system 100, including the medical device module 130, may be integral with the CT imaging device 102 or located remotely from the CT imaging device 102.

The medical device module 130 is adapted to obtain patient data regarding a patient and analyze the patient data to determine information regarding any personal medical device(s) a patient has. In various embodiments of the CT imaging system 100, the medical device module 130 is adapted to interface with a variety of information databases. An exemplary medical imaging network 200 is illustrated in FIG. 2. As shown in FIG. 2, the medical device module 130 of the exemplary embodiment is adapted to interface with electronic medical records (“EMR”) 210, hospital information systems (“HIS”) 220, radiology information systems (“RIS”) 230 and picture archiving and communication systems (“PACS”) 240. As shown in FIG. 2, the medical device module 130 of the exemplary embodiment is also adapted to interface with databases provided and/or maintained by medical device manufacturers 250, medical imaging scanner manufacturers 260 and/or regulatory agencies 270. The medical device module 130 may also be adapted to interface with various other databases or collections of information in additional embodiments. It should be understood that in various embodiments of the CT imaging system 100, the medical device module 130 does not interface with any databases. In additional embodiments of the CT imaging system 100, the medical device module 130 may interface with one or more of the databases set forth in FIG. 2, but may not interface with all of these databases.

In various embodiments of the CT imaging system 100, the medical device module 130 is adapted to analyze image data to determine the presence of a personal medical device. As used herein, “personal medical device” shall mean any medical device that is implanted fully or partially within a patient or is located externally and carried by or adhered to a patient, including but not limited to cardiac rhythm management devices, defibrillators, neurostimulators, drug infusion pumps (e.g., insulin pumps), cochlear implants, and retinal implants. The medical device module 130 employs a mathematical algorithm such as a thresholding, connected-component analysis, generalized Hough transform (GHT), model-based segmentation algorithm, or other suitable algorithm or algorithms to analyze image data for the presence of a personal medical device. The image data analyzed by the medical device module 130 may be obtained from a two-dimensional or three-dimensional scout scan (i.e., surview scan) or from a full scan. In various embodiments of the CT imaging system 100, the medical device module 130 performs this analysis on image data that is acquired from a patient during a current imaging procedure (and stored in the memory 110 of the CT imaging system 100 or in some other location) or on image data that was previously obtained from the patient during prior imaging procedure(s) and stored in the picture archiving and communication system 240 or in some other location. The image data that is analyzed by the medical device module 130 to determine the presence of a personal medical device may also be used for attenuation correction.

In various embodiments of the CT imaging system 100, the medical device module 130 is adapted to determine the location of the personal medical device. In such embodiments, the medical device module 130 analyzes data derived from anatomic segmentation algorithms, such as thorax or cardiac anatomic segmentation algorithms, to determine and record the location of a personal medical device relative to internal or external fiducial markers, such as the sternum, ribs or clavicle. In other embodiments, the medical device module 130 determines the location of a personal medical device relative to a planned imaging scan range and records the location of the medical device relative to the scan range. In yet further embodiments, the medical device module 130 determines the relative location of a personal medical device by analyzing image data that was previously obtained from the patient during prior imaging procedure(s) and comparing (e.g., image registration techniques) to image data that is acquired from a patient during a current imaging procedure.

As mentioned previously, various embodiments of the CT imaging system 100 include a medical device module 130 that is adapted to interface with databases. Such databases may include EMR 210, HIS 220, RIS 230, PACS 240 and medical device manufacturer registries 250 illustrated in FIG. 2. The medical device module 130 of these embodiments may poll one or more of these databases to gather information regarding the presence, location and/or additional characteristics of a particular patient's personal medical device.

For example, the medical device module 130 may poll EMR 210 to determine if a patient has a personal medical device and if so gather information regarding the personal medical device. Such information may include for example the type, location, orientation, manufacturer, model, or other characteristics of the device. In a similar manner, the medical device module 130 may also gather similar information from other databases, such as HIS 220 or RIS 230 for example. The medical device module 130 may determine that a patient has a specific device (e.g. a particular model of defibrillator) or may determine that the patient has a device that falls within a general category or series (e.g. a defibrillator, a particular series of defibrillator models, etc.). If it is known or determined that a patient has a particular make and model or category of personal medical device, the medical device module 130 may then poll the device manufacturer database 250, medical imaging scanner manufacturer database 260, or regulatory agency databases 270 to gather information regarding that particular device model or category of devices such as operating parameters, radiation sensitivity profiles or other characteristics of the device.

In various embodiments, the medical device module 130 collects and analyzes information (i.e. patient data) from multiple sources to classify the personal medical device. For example, in various embodiments the medical device module 130 uses information gathered from image data to classify the personal medical device. For example, the medical device module 130 may use morphologic and attenuation image feature data (including that of multi-energy or spectral features) gathered from a scout scan or full scan. The medical device module 130 may also combine this information with non-image data (e.g., information gathered from EMR 210, HIS 220, and/or RIS or other databases) to further classify the personal medical device. For instance, the medical device module 130 may use a neural network, genetic algorithm, support vector machine or other methods in analyzing image data to determine the type of medical device implanted within a patient. Once the medical device module 130 classifies the medical device, this information can be used to reference databases to determine additional characteristics of the medical device. For example, once the medical device module 130 classifies the type, manufacturer and/or model of the personal medical device, the medical device module 130 may poll medical device manufacturer databases 250, medical imaging scanner manufacturer databases 260 and/or regulatory agency databases 270 to determine the device's radiation sensitivity profile. Or, for example, the medical device module may determine information about the attenuation properties of a personal medical device for use in attenuation correction.

In various embodiments of the CT imaging system 100, the medical device module 130 provides the clinician or other operator of the CT imaging system 100 with a warning if a personal medical device is detected within a patient prepared to undergo an imaging procedure. The warning provided may be an auditory warning and/or visual warning, or may be some other form of warning. In various embodiments, the medical device module 130 highlights the location of a personal medical device on a reconstructed image (such as a scout scan) by the use of a suitable method. Such methods may provide the operator of the CT imaging system 100 with information regarding the location, orientation, or type of the personal medical device. The medical device module 130 presents this information to the operator of the CT imaging system 100 when desired either visually or in some other fashion, such as a color or shaded overlay (as illustrated for example in FIG. 4B). This information may be presented to the CT operator on a scanning console, a gantry display, such as a touch screen display, or in some other fashion. In addition to a warning and/or information regarding the personal medical device, the medical device module 130 may also guide the CT operator through various steps of the imaging procedure. For example, the CT operator may be guided through various steps that are needed in response to the detection of a personal medical device in a patient by prompts presented on a gantry touch screen display.

In various embodiments of the CT imaging system 100, the medical device module 130 may also transmit a notification (e.g., email, page, SMS, phone call, etc.) to a senior technologist, specialist (e.g., cardiologist, neurologist, etc.), radiologist or other medical professional. This notification may be transmitted prior to the commencement of a scanning procedure, during the procedure, or after the procedure. In this manner, such medical personnel may be summoned if additional expertise is required either prior to or after the scanning procedure. For example, the expertise of a cardiologist may be requested prior to the commencement of a particular scanning procedure due to the location of a cardiac rhythm management device within a planned scanned range.

Once the medical device module 130 determines that a patient has a personal medical device, and classifies the device, and informs the operator of the presence of the device, the medical device module 130 of various embodiments of the present invention optionally customizes the planned imaging procedures for a particular patient. For example, the medical device module 130 may use information gathered about the type and location of the personal medical device to adjust the radiation dose or radiation dose rate administered over the personal medical device. This can decrease the risk that the primary beam exposure of the medical device exceeds a pre-defined radiation exposure threshold. Such pre-defined radiation exposure thresholds may be established for a particular personal medical device by a manufacturer of personal medical devices, a local hospital policy, a regulatory agency or other institution in combination with patient-specific features (e.g., body habitus, weight). Once the medical device module 130 determines that a patient has a particular type of personal medical device, the medical device module 130 may poll various databases as discussed above to determine the radiation exposure threshold that has been set for that type of device.

In addition, the medical device module 130 may automatically adjust or alter additional parameters of a medical imaging procedure or suggest manual adjustments in response to information gathered about a personal medical device. Such parameters include tube voltage, tube current, gantry rotation time, helical pitch, and other parameters. Furthermore, the medical device module 130 may adjust dose modulation parameters such as for example automatic tube current selection, z-axis dose modulation, angular dose modulation, combination z-axis and angular dose modulation, and/or organ-specific dose modulation. The medical device module 130 may also select or deselect wedge or bowtie compensation filters and dynamic end-effect collimation dependent upon the information gathered regarding the personal medical device. In additional embodiments, the medical device module 130 alters or adjusts additional parameters, settings, or characteristics of medical imaging procedures to decrease the risk that the imaging procedure will damage or otherwise interfere with the operation of a personal medical device. In various embodiments, the medical device module 130 may also plan or optimize an entire therapy (e.g., radiation therapy) for a particular patient as opposed to customizing just one medical imaging procedure.

In various embodiments of the CT imaging system 100, the medical device module 130 alters the scan range of a planned imaging procedure based on the type or location of a personal medical device. For example, if the medical device module 130 determines that the patient has an implanted cardiac rhythm management device (ICMRD) or some other personal medical device that is located within or near a planned scan range, the medical device module may alter the scan range so as to avoid interfering with the ICMRD.

In addition, the medical device module 130 may propose or suggest one or more alternative scan protocols to the operator that would pose a decreased risk of interfering with the personal medical device if it is determined that a personal medical device is located within or near a planned scan range. If it is determined that a personal medical device is located within a planned scan range and the planned scan range cannot or will not be altered, the medical device module 130 of various embodiments may balance the image quality with the risk of device interference or malfunction. In such instances, the medical device module may alter or customize a variety of parameters of the medical imaging procedure that will result in a decrease of image quality but also result in a decreased risk of interference with the personal medical device.

In various embodiments of the CT imaging system 100, the medical device module 130 moves the couch supporting the patient during imaging to facilitate the placement of optional x-ray shielding, such as a bismuth shield, over the region of the patient's body having the personal medical device to shield the medical device from radiation exposure. To further facilitate this radiation shielding process, the medical device module 130 may also project lasers onto or otherwise mark the location of the personal medical device to indicate to the operator the region of the patient's body over which the shield should be located.

The medical device module 130 of various embodiments of the CT imaging system 100 optionally monitors the patient's physiological signals, such as electrocardiography (ECG), electroencephalography (EEG) or other physiological signals, during medical imaging procedures to monitor for potential CT induced irregularities. For example, if the medical device module 130 detects that a patient has an implanted cardiac rhythm management device (ICMRD), the medical device module 130 optionally monitors the patient's heart activity via ECG to warn the operator if there are any irregularities with the patient's heart activity during the imaging procedure. In this manner, the imaging procedure may be stopped if the patient's ICMRD malfunctions or if there are any other irregularities so that the patient can be stabilized and immediate medical attention can be provided. The physiological signals that are monitored by the medical device module 130 can be tailored based on the type of personal medical device that the patient has. For example, different physiological signals may be monitored by the medical device module 130 if the patient has an insulin pump as opposed to a cardiac pacemaker.

The medical device module 130 of various embodiments of the CT imaging system 100 is adapted to update various databases, such as EMR 210, HIS 220 and/or RIS 230, with information gathered about a particular patient's personal medical device(s). For example, the medical device module 130 adds or updates information regarding the presence, location, orientation, type, manufacture and model of personal medical device that a patient has to these databases. In addition, the medical device module 130 of various embodiments may add or update information regarding the scan parameters used for a particular medical imaging procedure or the patient's physiological signals that were measured during the imaging procedure to these databases. Furthermore, the medical device module 130 optionally notifies the appropriate medical professionals, such as the patient's primary care doctor, cardiologist, neurologist, or other health care workers, that the patient's medical records have been altered or updated. This may alert them to monitor the patient to determine if there are any potential radiation-induced changes to the device or its behavior.

The medical device module 130 of various embodiments of the CT imaging system 100 generates a survey or questionnaire after a medical imaging procedure for the CT technologist or patient to confirm the presence or absence of any CT-induced interactions with a personal medical device. Following the completion of the questionnaire by the CT operator or patient, the medical device module 130 optionally submits the results of the survey along with information regarding the personal medical device and the medical imaging procedure conducted to a hospital quality assurance department, scanner manufacturer, personal medical device manufacturer and/or regulatory agencies. One such regulatory agencies' service is MedWatch, the U.S. Food and Drug Administration's voluntary safety information and adverse event reporting program.

Referring now to FIG. 3, an exemplary personal medical device detection and response method 300 according to one aspect of the present invention is illustrated. In step 302, the CT imaging system 100 is utilized to obtain scout scan or surview image data 306 of the imaged subject 104. In step 304, image data 306 from previous imaging procedures of the patient is obtained from the picture archiving and communication system 240 or other source(s). As mentioned previously, image data 306 from either a scout scan or from a previous scanning procedure can be used for the purpose of determining the presence of a personal medical device in accordance with aspects of the present invention. For certain imaging modalities, such as MR, scout scans may not be utilized for various reasons. Accordingly, depending on whether image data from a scout scan or from previous scanning procedures is to be used, only one of step 302 or step 304 may be completed. However, in additional embodiments that employ image data from both a scout scan and from a previous scanning procedure to determine the presence of a personal medical device, both steps 302 and 304 are completed. In yet additional embodiments, no image data is analyzed. Rather, only information obtained from one or more databases (such as EMR 210, HIS 220, RIS 230, PACS 240 and/or device manufacturer registries 250, etc.) in step 312 is used to determine information about the device.

In certain embodiments, image data from an image modality other than the one the patient is being prepared to undergo is used. For example, prior to commencing an MR imaging procedure, a CT scout scan or CT image data from previous CT scans of the patient may be analyzed to help ensure that no non-MR compatible personal medical device enters the magnetic/RF field.

In step 308, the medical device module 130 analyzes the image data 306 for the presence of a personal medical device. As mentioned previously, the medical device module 130 employs the use of mathematical algorithm(s) such as thresholding, connected-component analysis, generalized Hough transform (GHT), model-based segmentation algorithm(s), or other suitable algorithm(s) to analyze the image data 306 for the presence of a personal medical device. If no device is determined to be present, the process 300 stops. If a device is determined to be present, the process 300 continues.

In step 310, the medical device module 130 analyzes image data 306 to determine the location of the personal medical device if any is present. For example, the medical device module 130 analyzes data derived from anatomic segmentation algorithms, such as thorax or cardiac anatomic segmentation algorithms, to determine the location of the personal medical device relative to internal or external fiducial markers of the patient, such as the sternum, ribs or clavicle.

In step 312, the medical device module 130 polls one or more databases, such as electronic medical records (“EMR”) 210, hospital information systems (“HIS”) 220, radiology information systems (“RIS”) 230, picture archiving and communication systems (“PACS”) 240, personal medical device manufacturer database(s) 250, medical imaging scanner manufacturer database(s) 260 and/or regulatory agency database(s) 270 or other databases, to gather information about a patient's personal medical device(s). The medical device module 130 polls these databases to gather information regarding the presence, location, orientation, type, model, manufacturer and/or radiation sensitivity profile or any other relevant characteristics of any personal medical devices a particular patient may have. In certain embodiments of the present invention, the medical device module 130 may poll one or more of these databases. In additional embodiments, the medical device module 130 may not poll any databases, but rather rely solely on image data 306.

The medical device module 130 may be connected to each of these databases in a variety of ways, such as a wired network, wireless network, peer to peer network, client/server network or any other suitable method. Also, the medical device module 130 may not be directly connected to these databases. Rather the contents of these databases could be uploaded to a memory device located within the medical device module 130 itself, the memory 110 of the CT imaging system 100, or some other memory device that the medical device module 130 is connected to and gathers information from.

In step 314, the medical device module 130 utilizes information gathered from the image data in step 308 and/or from the polling of database(s) in step 312 to classify the personal medical device if any is present. In various embodiments the medical device module 130 uses morphologic and attenuation image feature data (including that of multi-energy or spectral features) or other image data gathered from step 308 and/or non-image data gathered from step 312 to classify the personal medical device. For instance, the medical device module 130 may use a neural network, genetic algorithm, support vector machine or other methods in analyzing image data to determine the type of medical device implanted within a patient. This information is then combined with information gathered from the polled databases such as device type, manufacturer, model, radiation sensitivity profile and other characteristics of the medical device.

The steps 312 and 314 may be performed iteratively in series to reconcile information obtained from different sources. In various embodiments of the CT imaging system 100, the medical device module 130 may poll multiple databases in step 312 either simultaneously or in series. Also, the medical device module 130 may gather information from a database or databases in step 312 to gather certain information and then re-poll these same database(s) or additional database(s) to gather additional information. For example, the medical device module 130 may determine the type, manufacturer and model of personal medical device based on the polling of one database, such as the hospital information systems database 220. That information may then be used for example to poll another database, such as a device manufacturer database 250, to determine additional information such as the radiation sensitivity profile of the personal medical device.

If a personal medical device is detected by the medical device module 130, the medical device module 130 notifies the CT operator of the presence of the personal medical device by an auditory and/or visual warning in step 316. For example, the medical device module 130 may give an audible beep or other warning to alert the CT operator that a personal medical device is present and certain actions may be required of the CT operator.

There may be a discrepancy regarding the presence of a personal medical device between the information gathered from the databases in step 312 and the determination made by the medical device module 130 based on image data in step 308. In that event, the medical device module 130 will indicate to the CT operator that additional investigation is required in step 318. For example, the medical device module 130 may have determined that a personal medical device is present based on the analysis of the image data 306 at step 308, while no record of such a personal medical device has been detected from the polled databases at step 312. Likewise, the polled databases at step 312 could include information regarding the presence of a personal medical device that is no longer present or is not detected in the image data 306 by the medical device module 130.

Similarly, discrepancies regarding the presence of a personal medical device could also arise if image data is used from both a scout scan and from previous imaging procedures of the patient. For example, the patient may have had a personal medical device at the time of the previous imaging procedure that was thereafter removed or changed. In such instances, the CT operator or other medical technician will carry out a manual personal medical device detection procedure in response to the prompt of step 318 to determine whether the patient has a personal medical device. These procedures may include a visual check, inquiry of the patient, palpation of relevant patient regions, or other inquiries. Subsequent to this manual investigative procedure, the CT operator may input information into the medical device module 130 to resolve the discrepancy regarding the presence of a personal medical device.

In step 320, the medical device module 130 highlights the location of the personal medical device on a reconstructed image (such as a scout scan). For example, a color or shaded overlay may be used. In this way, the operator of the CT imaging system 100 is provided with information regarding the location of the personal medical device. In various embodiments, the medical device module 130 also visually depicts the location of the personal medical device relative to a planned imaging scan range for the operator of the CT imaging system 100 via the display 140 or some other display device when desired.

FIG. 4A illustrates an exemplary reconstructed CT scout scan image 400 generated by a software program. The image 400 includes an implanted cardiac rhythm management device (ICMRD) 410. It also illustrates a planned scanned range 420 that includes the ICMRD 410. Referring now to FIG. 4B, an exemplary reconstructed CT scout scan image 400′ generated by a software program according to one aspect of the present invention is illustrated. The image 400′ was generated based on the same data used to generate the image 400. In the scout scan image 400′ of FIG. 4B, however, the implanted cardiac rhythm management device 410 has been detected and highlighted in relation to a planned scan range 430.

In step 322, the medical device module 130 customizes the medical imaging procedure in response to the detection of a personal medical device. As described previously, the medical device module 130 may use information gathered about the type, location and/or orientation of the personal medical device to adjust the radiation dose or radiation dose rate that is to be administered over the personal medical device. In addition, the medical device module 130 may adjust tube voltage, tube current, gantry rotation time, helical pitch, or other parameters of the planned scanning procedure. Furthermore, the medical device module 130 may adjust dose modulation parameters (e.g., automatic tube current selection, z-axis dose modulation, angular dose modulation, combination z-axis and angular dose modulation, and/or organ specific dose modulation). The medical device module 130 may also select or deselect wedge or bowtie compensation filters or dynamic end-effect collimation dependent upon the information gathered regarding the personal medical device. In additional embodiments, the medical device module 130 alters or adjusts additional parameters, settings, or characteristics of medical imaging procedures to decrease the risk that the imaging procedure will damage or otherwise interfere with the operation of a personal medical device.

In various embodiments of the CT imaging system 100, the medical device module 130 alters the scan range of a planned imaging procedure based on the type, location and/or orientation of a personal medical device. Referring again to FIG. 4B, the planned scan range 430 has been altered in comparison to the planned scan range 420 of FIG. 4A. The scan range 430 has been altered to avoid scanning over the implanted cardiac rhythm management device 410. In addition, the medical device module 130 may propose or suggest one or more alternative scan protocols to the operator that would pose a decreased risk of interfering with the personal medical device if it is determined that a personal medical device is located within or near a planned scan range.

Also, as described previously, in various embodiments of the CT imaging system 100, the medical device module 130 moves the couch supporting the patient during imaging to facilitate the placement of optional x-ray shielding, such as a bismuth shield, over the region of the patient's body having the personal medical device to shield the medical device from radiation exposure. To further facilitate this radiation shielding process, the medical device module 130 may also project lasers onto or otherwise mark the location of the personal medical device to indicate to the operator the region of the patient's body over which the shield should be located.

In step 324, the medical device module 130 monitors a patient's physiological signals during a medical imaging procedure, such as electrocardiography (ECG), electroencephalography (EEG) or other physiological signals, to monitor for potential CT induced irregularities. In this manner, the imaging procedure may be stopped if there are any irregularities so that the patient can be stabilized and immediate medical attention can be provided. The physiological signals that are monitored by the medical device module 130 can be tailored based on the type of personal medical device that the patient has. In step 326, the medical device module 130 warns the CT operator and/or stops the medical imaging process if any dangerous irregularities occur with the patient's physiological signals.

In step 328, the medical device module updates various databases, such as electronic medical records (“EMR”) 210, hospital information systems (“HIS”) 220, radiology information systems (“RIS”) 230, with information gathered about a particular patient's personal medical device(s). For example, the medical device module 130 adds or updates information regarding the presence, location, type, orientation, manufacture, model of personal medical device that a patient has to these databases. In addition, the medical device module 130 of various embodiments adds or updates information regarding the scan parameters used for a particular medical imaging procedure or the patient's physiological signals that were measured during the imaging procedure to these databases as well. Furthermore, in step 328, the medical device module 130 optionally notifies the appropriate medical professionals that the patient's medical records have been altered or updated and alerts them to monitor the patient to determine if there are any potential radiation-induced changes to the device or its behavior.

In step 330, the medical device module 130 generates a survey or questionnaire for the CT operator. The purpose of this survey is to confirm the presence or absence of any CT-induced interactions with a personal medical device. Following the completion of the questionnaire by the CT operator, the medical device module 130 optionally submits the results of the survey along with information regarding the personal medical device and the medical imaging procedure conducted to a hospital quality assurance department, scanner manufacturer, personal medical device manufacturer and/or regulatory agency.

Various embodiments of the present invention may include the previously discussed method steps in a variety of orders. For example, in various embodiments, one or more database(s) may be polled prior to the analysis of image data 306. For instance, a patient may be registered on a CT imaging system for an imaging procedure. Once the patient has been registered, the medical device module 130 may then poll one or more databases (such as EMR 210, HIS 220, RIS 230, PACS 240 and/or personal medical device manufacturer database(s) 250) to determine if a patient has a personal medical device. If the polling of these database(s) indicates the history of a personal medical device, a notification regarding the presence of the device and any other known information about the device may be communicated to the CT operator. If image data 306 of the patient (such as scout scan or image data from a previous imaging procedure) is available, the image data 306 may then be analyzed for the presence of a personal medical device. If no image data 306 of the patient is available, a scout scan of the patient may be conducted. Alternatively, in certain embodiments, no image data 306 is analyzed and only information obtained from the polling of one or more database(s) is used.

In addition, various embodiments may include either more or less steps than those previously described. For example, one embodiment of the present invention may identify the presence and location of a personal medical device but not alter the planned medical imaging procedure in response to the detection of the personal medical device.

The present invention may be implemented in a variety of ways. The medical device module 130 may be provided as a component of a medical imaging device, such as a CT scanner. The medical device module 130 may also be provided on a workstation linked to a medical imaging device, as a component of a network storage device, or of an imaging archiving database, such as PACS, or as an application within a host software. The medical device module 130 may also be implemented on and/or connected to a medical imaging device via a software application, web service, and/or application service provider (ASP) model via standard image/data transfer protocols and standards (e.g., DICOM, HL7, HTTP, SOAP, XML). As described previously, this invention is applicable to a variety of imaging modalities, such as PET, SPECT, CT, MR, ultrasound, x-ray, fluoroscopy, or other image modalities or a system combining one or more of these image modalities. The medical device module 130 may comprise multiple parts or components that are each located in different locations.

The aforementioned functions, such as for example, analyzing image data to determine the presence of a personal medical device, analyzing image data to determine the location of a personal medical device, classifying a personal medical device based upon image data and information gathered from the polling of database(s), customizing, altering, initiating and/or terminating scans, selecting desired scan or reconstruction protocols, manipulating the volumetric data, and the like, can be performed as software logic. “Logic,” as used herein, includes but is not limited to hardware, firmware, software and/or combinations of each to perform a function(s) or an action(s), and/or to cause a function or action from another component. For example, based on a desired application or needs, logic may include a software controlled microprocessor, discrete logic such as an application specific integrated circuit (ASIC), or other programmed logic device. Logic may also be fully embodied as software.

“Software,” as used herein, includes but is not limited to one or more computer readable and/or executable instructions that cause a computer or other electronic device to perform functions, actions, and/or behave in a desired manner. The instructions may be embodied in various forms such as routines, algorithms, modules or programs including separate applications or code from dynamically linked libraries. Software may also be implemented in various forms such as a stand-alone program, a function call, a servlet, an applet, instructions stored in a memory, part of an operating system or other type of executable instructions. It will be appreciated by one of ordinary skill in the art that the form of software is dependent on, for example, requirements of a desired application, the environment it runs on, and/or the desires of a designer/programmer or the like.

The systems and methods described herein can be implemented on a variety of platforms including, for example, networked control systems and stand-alone control systems. Additionally, the logic, databases or tables shown and described herein preferably reside in or on a computer readable medium, such as a component of the imaging system 100 like the memory 110 or the image processor 120. Examples of different computer readable media include Flash Memory, Read-Only Memory (ROM), Random-Access Memory (RAM), programmable read-only memory (PROM), electrically programmable read-only memory (EPROM), electrically erasable programmable read-only memory (EEPROM), magnetic disk or tape, optically readable mediums including CD-ROM and DVD-ROM, and others. Still further, the processes and logic described herein can be merged into one large process flow or divided into many sub-process flows. The order in which the process flows herein have been described is not critical and can be rearranged while still accomplishing the same results. Indeed, the process flows described herein may be rearranged, consolidated, and/or re-organized in their implementation as warranted or desired.

The invention has been described with reference to the preferred embodiments. Modifications and alterations may occur to others upon reading and understanding the preceding detailed description. It is intended that the invention be constructed as including all such modifications and alterations insofar as they come within the scope of the appended claims or the equivalents thereof.

1. A method for detecting the presence of a personal medical device within a subject prepared to undergo a medical procedure, comprising the steps of:
obtaining patient data for the subject with a medical device module;
analyzing the patient data with the medical device module to determine if a personal medical device is present; and
providing information regarding the presence of the personal medical device.

2. The method of claim 1, wherein the patient data of the subject is obtained from image data.

3. The method of claim 2, wherein the image data is obtained from a scout scan of the subject or from at least one previous scanning procedure of the subject.

4. The method of claim 1, wherein the patient data of the subject is obtained by polling at least one database with the medical device module to gather information regarding the personal medical device.

5. The method of claim 4, wherein the polling of at least one database comprises the polling of at least one of an electronic medical records database, a hospital information system database, a radiology information system database, a picture archiving and communication systems database, a medical device manufacturer database, a medical imaging scanner manufacturer database, or a regulatory agency database.

6. The method of claim 4, wherein a prompt is given to an operator of the imaging system to conduct a manual medical device investigation if a discrepancy exists regarding the presence of a personal medical device between the information gathered from the at least one polled database and the image data.

7. The method of claim 1, further comprising the step of determining the location of the personal medical device with the medical device module.

8. The method of claim 1, further comprising the step of visually depicting the personal medical device on a reconstructed image of the subject relative to a planned scan range of the medical procedure.

9. The method of claim 1, further comprising the step of classifying the personal medical device with the medical device module based upon the analysis of the patient data by the medical device module.

10. The method of claim 9, wherein the classifying of the personal medical device comprises defining at least one or more of a type, manufacturer, model, or radiation sensitivity profile for the personal medical device.

11. The method of claim 1, further comprising the step of altering the medical procedure by the medical device module in response to the presence of a personal medical device.

12. The method claim 11, wherein the step of altering the medical procedure comprises altering at least one of the radiation dose, radiation dose rate, tube voltage, tube current, gantry rotation time, scan region or helical pitch of the medical procedure.

13. The method claim 11, wherein the step of altering the medical procedure comprises adjusting a dose modulation parameter.

14. The method claim 11, wherein the step of altering the medical procedure comprises selecting or deselecting a wedge or bowtie compensation filter or dynamic end-effect collimation.

15. The method of claim 1, further comprising the step of generating one or more proposed alternate medical procedures by the medical device module in response to the presence and location of a personal medical device.

16. The method of claim 1, further comprising the step of monitoring physiological signals of the subject with the medical device module during the medical procedure.

17. The method of claim 16, further comprising the step of notifying an operator of the medical imaging system if the monitoring of the physiological signals of the subject reveals any dangerous abnormalities.

18. The method of claim 1, further comprising the step of updating at least one database with information gathered by the medical device module regarding the personal medical device.

19. The method of claim 1, further comprising the step of generating a survey for the operator of the medical imaging system for gathering information regarding at least one of the personal medical device or the medical procedure.

20. A system for detecting the presence of a personal medical device within a subject, the system comprising:
a medical device module;
wherein the medical device module comprises a computer readable medium including logic adapted to obtain patient data for the subject; analyze the patient data to determine if a personal medical device is present; and provide information regarding the presence of the personal medical device.

21. The system of claim 20, wherein the patient data of the subject is obtained from image data.

22. The system of claim 21, wherein the image data is obtained from a scout scan of the subject or from at least one previous scanning procedure of the subject.

23. The system of claim 20, wherein the patient data of the subject is obtained by polling at least one database with the medical device module to gather information regarding the personal medical device.

24. The system of claim 23, wherein the medical device module is adapted to poll at least one of an electronic medical records database, a hospital information system database, a radiology information system database, a picture archiving and communication systems database, a medical device manufacturer database, a medical imaging scanner manufacturer database, or a regulatory agency database.

25. The system of claim 23, wherein the medical device module is adapted to prompt the operator of the imaging system to conduct a manual medical device investigation if a discrepancy exists regarding the presence of a personal medical device between the information gathered from the at least one polled database and the image data.

26. The system of claim 20, wherein the medical device module is adapted to determine the location of the personal medical device.

27. The system of claim 20, wherein the medical device module is adapted to visually depict the personal medical device on a reconstructed image of the subject relative to a planned scan range of the medical procedure.

28. The system of claim 20, wherein the medical device module is adapted to classify the personal medical device based upon the analysis of the patient data.

29. The system of claim 28, wherein the medical device module is adapted to define at least one or more of a type, manufacturer, model, or radiation sensitivity profile for the personal medical device.

30. The system of claim 20, wherein the medical device module is adapted to alter the medical procedure in response to the presence of a personal medical device.

31. The system of claim 30, wherein the medical device module is adapted to alter at least one of the radiation dose, radiation dose rate, tube voltage, tube current, gantry rotation time, scan region or helical pitch of the medical procedure.

32. The system of claim 30, wherein the medical device module is adapted to adjust a dose modulation parameter.

33. The system of claim 30, wherein the medical device module is adapted to select or deselect a wedge or bowtie compensation filter or dynamic end-effect collimation.

34. The system of claim 20, wherein the medical device module is adapted to generate one or more proposed alternate medical procedures in response to the presence and location of a personal medical device.

35. The system of claim 20, wherein the medical device module is adapted to monitor physiological signals of the subject during the medical procedure.

36. The method of claim 35, wherein the medical device module is adapted to notify an operator of the medical imaging system if the monitoring of the physiological signals of the subject reveal any dangerous abnormalities.

37. The system of claim 20, wherein the medical device module is adapted to update at least one database with information gathered regarding the personal medical device.

38. The system of claim 20, wherein the medical device module is adapted to generate a survey for the operator of the medical imaging system for gathering information regarding at least one of the personal medical device or the medical procedure.

39. A system to gather information regarding a personal medical device within a subject to be imaged, the system comprising a medical device module comprising a computer readable medium including logic adapted to poll at least one database to gather information regarding the personal medical device.

40. The system of claim 39, wherein the medical device module is adapted to analyze image data to determine one or more characteristic of a personal medical device within the subject and use the one or more characteristic to perform the poll.

41. The system of claim 39, wherein the medical device module is adapted to receive information identifying the subject and use the identifying information to perform the poll.

42. The system of claim 39, wherein the medical device module is adapted to update at least one database with information gathered by the medical device module regarding the personal medical device.
